(19) United States
(12) Patent Application Publication
(10) Pub. No.: US 2008/0014998 A1
(43) Pub. Date: Jan. 17, 2008

(54) IP MULTIMEDIA SUBSYSTEM SERVICE APPARATUS AND METHOD IN MOBILE TERMINAL

(75) Inventor: Jong-Mu Choi, Gunpo-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/774,203

(22) Filed: Jul. 6, 2007

(30) Foreign Application Priority Data
Jul. 13, 2006 (KR) 2006-0065630

(51) Int. Cl. H04M 1/73

(52) U.S. Cl. 455/572

(57) ABSTRACT

Provided is an Internet Protocol (IP) Multimedia Subsystem (IMS) service apparatus and method in a mobile terminal. The method includes registering the mobile terminal to an IMS server over a mobile communication network, checking whether an invite request message is for requesting an IMS service requiring a connection with a wireless Local Area Network (LAN), supplying power to a wireless LAN communication unit, attempting a connection with a wireless LAN Access Point (AP) via the wireless LAN communication unit supplied with power, generating an invite response message including information on the wireless LAN AP, and sending the invite response message to a terminal, which has sent the invite request message, over the wireless LAN.

### PRIORITY

This application claims priority under 35 U.S.C. § 119 to an application filed in the Korean Intellectual Property Office on Jul. 13, 2006 and assigned Serial No. 2006-65630, the contents of which are incorporated herein by reference.

### BACKGROUND OF THE INVENTION

1. Field of the Invention

The present invention relates generally to an Internet Protocol (IP) Multimedia Subsystem (IMS) service apparatus and method in a mobile terminal accessible to a wireless Local Area Network (LAN) and a mobile communication system, and in particular, to an IMS service apparatus and method in a mobile terminal, for supplying power to a wireless LAN communication unit only upon requiring and enabling a connection with a wireless LAN, thereby realizing power saving, when the mobile terminal provides an IMS service.

2. Description of the Related Art

The recent development of portable electronic equipment including mobile computers and mobile phones has led to active research for wireless access of a wired network such as an Intranet or the Internet and World Wide Web (WWW).

It has been known that a wireless LAN is an effective technology for accessing the wired network at low cost and high speed. The Third Generation (3G) mobile communication system, such as Code Division Multiple Access (CDMA) 2000, Wideband Code Division Multiple Access/Universal Mobile Telecommunications System (WCDMA/UMTS), General Packet Radio System (GPRS), and CDMA 2000 1× EVolution Data and Voice (EV-DV), realizes high speed data transport over a wireless channel, thereby enabling an interworking terminal (a mobile station or user equipment) to access a packet communication network such as Internet over a cellular mobile communication network.

However, the use of advanced wireless access technology requires a very high cost. Thus, a demand for research, development and standard action for interworking between the mobile communication network and the wireless LAN by the interworking terminal accessible to both the mobile communication network and the wireless LAN is increasing. The main object of the interworking is to provide a service of the mobile communication network using the wireless LAN that is inexpensive and large in capacity.

Unlike the mobile communication network, an IEEE 802.11 based wireless LAN has a relatively narrow service area. Thus, a mobile terminal should always maintain a reception standby mode to use the wireless LAN because it cannot expect a serviceable area without maintaining the reception standby mode. Therefore, the conventional wireless LAN causes power consumption even when a wireless LAN communication unit is not used.

Research is being conducted on IP Multimedia Subsystem (IMS) service in a mobile terminal accessible to a wireless LAN and a mobile communication system. In the IMS service, traffic is sparse or bursty in characteristic. Accordingly, there is a need for a power saving IMS service apparatus and method in the mobile terminal, which service is provided by a mobile communication network when traffic is sparse, and is provided by the wireless LAN when the traffic is bursty, thereby supplying power to a communication unit only in use of the wireless LAN.

### SUMMARY OF THE INVENTION

An aspect of the present invention is to substantially solve at least the above problems and/or disadvantages and to provide at least the advantages below. Accordingly, an aspect of the present invention is to provide an IP multimedia subsystem service apparatus and method in a mobile terminal accessible to a wireless LAN and a mobile communication system, for reducing power consumption.

Another aspect of the present invention is to provide an IP multimedia subsystem service apparatus and method in a mobile terminal accessible to a wireless LAN and a mobile communication system, for supplying power to a wireless LAN communication unit only upon communication by the wireless LAN, thereby reducing power consumption.

A further aspect of the present invention is to provide an IP multimedia subsystem service apparatus and method in a mobile terminal accessible to a wireless LAN and a mobile communication system, for checking the use or nonuse of a wireless LAN communication unit by an invite request message received from a mobile communication network, and supplying power to the wireless LAN communication unit only upon communication by the wireless LAN, thereby reducing power consumption.

The above aspects are achieved by providing an IP multimedia subsystem service apparatus and method in a mobile terminal accessible to a wireless LAN and a mobile communication system.

According to the present invention, there is provided an IMS service apparatus having a power saving function in a mobile terminal. The apparatus includes a mobile communication unit connecting with a mobile communication network, communicating with an IMS server, registering the mobile terminal to the IMS server, and receiving an invite request message, a wireless LAN communication unit for searching an accessible wireless LAN Access Point (AP), and sending an invite response message upon connection with the wireless LAN AP, a message processor for, upon receipt of the invite request message, checking whether the received invite request message is for requesting an IMS service requiring a connection with a wireless LAN, and, upon checking that the IMS service requires the connection with the wireless LAN, attempting a connection with the wireless LAN AP via the wireless LAN communication unit, and, upon connection with the wireless LAN AP, generating an invite response message including information on the wireless LAN AP, and sending the generated invite response message to a terminal, which has sent the invite request message, via the wireless LAN communication unit, a power source for supplying power to the wireless LAN communication unit, and a power control unit for controlling the power source to supply power to the wireless LAN communication unit when the invite request message received from the message processor requires the connection with the wireless LAN.

According to the present invention, there is provided an IMS service method having a power saving function in a mobile terminal. The method includes registering the mobile terminal to an IMS server over a mobile communication network, upon receipt of an invite request message over the mobile communication network, checking whether the invite request message is a message for requesting an IMS service requiring a connection with a wireless LAN, upon checking that the IMS service requires the connection with the wireless LAN, supplying power to a wireless LAN communication unit, attempting a connection with a wireless LAN AP via the wireless LAN communication unit supplied with power, upon the connection with the wireless LAN AP, generating an invite response message including information on the wireless LAN AP, and sending the invite response message to a terminal, which has sent the invite request message, over the wireless LAN.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a procedure of providing an IMS service in an IMS service system with a mobile terminal according to the present invention;

FIG. 2 illustrates an IMS service apparatus having a power saving function in a mobile terminal accessible to a wireless LAN and a mobile communication system according to the present invention; and

FIG. 3 illustrates a procedure of receiving an invite request message and providing an IMS service in a mobile terminal accessible to a wireless LAN and a mobile communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

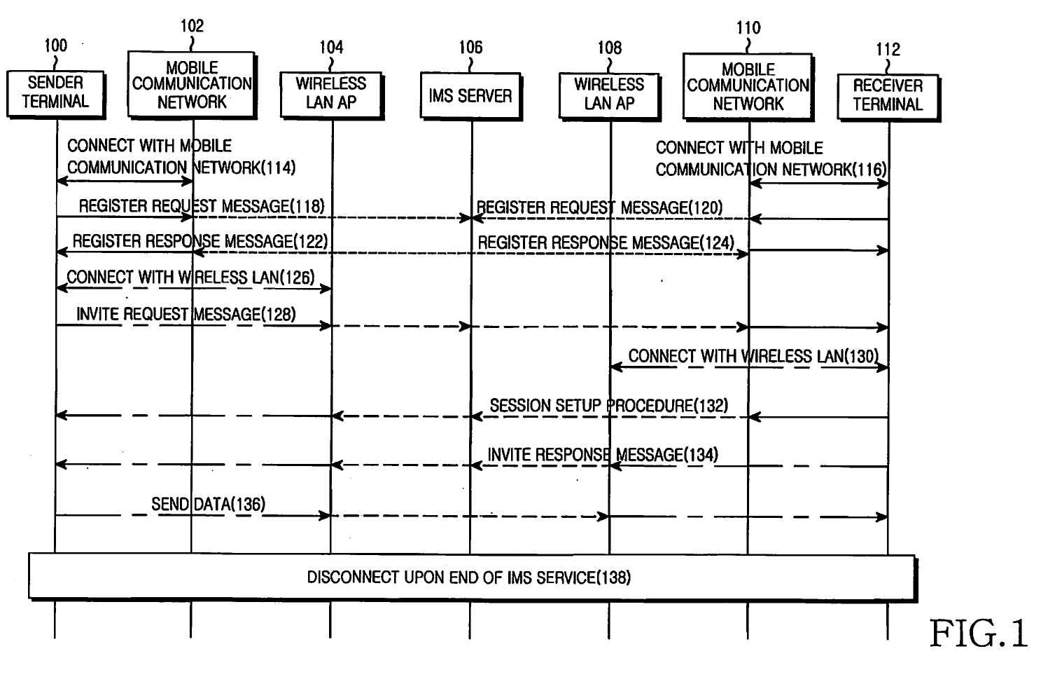

FIG. 1 illustrates a procedure of providing an IMS service in an IMS service system with a mobile terminal according to the present invention. In FIG. 1, solid lines represent connections between terminals 100 and 112 and mobile communication networks 102 and 110. Dotted lines represent a connection relationship in an Internet network. Chain lines represent connections between the terminals 100 and 112 and wireless LAN APs 104 and 108.

Referring to FIG. 1, the sender terminal 100 and the receiver terminal 112 connect with the mobile communication networks 102 and 110 each including them, in mobile communication network connecting steps 114 and 116. The sender terminal 100 and the receiver terminal 112 each send register request messages 118 and 120 to an IMS server 106 in order to be provided with the IMS service. The sender terminal 100 and the receiver terminal 112 each receive register response messages 122 and 124 from the IMS server 106, and complete registration for the IMS service. The register request messages 118 and 120 are defined by Session Initiation Protocol (SIP) of “IETF (Internet Engineering Task Force) RFC (Request For Comments) 2543”, which is a standard protocol used for call connection and management of a session based application service in IMS. The register response messages 122 and 124 can be expressed using 2000K defined by the SIP. The 2000K represents an acceptance of the request.

After the registration to the IMS server 106, the sender terminal 100 supplies power to a wireless LAN communication unit, searches and connects with the neighbor wireless LAN AP 104 in wireless LAN connecting step 126, when the sender terminal 100 generates an event for requesting the IMS service communicating with the receiver terminal 112 over the wireless LAN. After that, the sender terminal 100 generates and sends an invite request message 128 to the mobile communication network 110 including the receiver terminal 112, via the IMS server 106. The generation of the event for requesting the IMS service over the wireless LAN is that the IMS service requested by a user is of a type requesting burst traffic. The IMS service requesting the burst traffic is Voice over IP (VoIP), Video Sharing and File Sharing.

The invite request message 128, defined by the SIP, includes Session Description Protocol (SDP) that is information on an IMS service type. The SDP is defined by “IETF RFC 2327”, which is a standard protocol used for expressing a feature of a session based application service in the SIP.

If receiving the invite request message 128 over the mobile communication network 110, the receiver terminal 112 checks the SDP included in the invite request message 128, and checks whether the IMS service requires a connection with the wireless LAN. When it is checked that the IMS service requires the connection with the wireless LAN, the receiver terminal 112 supplies power to a wireless LAN communication unit, searches and connects with the neighbor wireless LAN AP 108 in wireless LAN connecting step 130. During the wireless LAN connecting step 130, the receiver terminal 112 performs a session setup procedure 132, which involves ringing or resource reservation until the receiver terminal 112 connects with the wireless LAN.

The receiver terminal 112 generates and sends an invite response message 134 to the IMS server 106 via the wireless LAN AP 108 when it connects with the wireless LAN AP 108 in the wireless LAN connecting step 130. The IMS server 106 receives and searches the invite response message 134 for an address of the wireless LAN AP 104 adjacent to the sender terminal 100, and sends the invite response message 134 to the wireless LAN AP 104 which sends the received invite response message 134 to the sender terminal 100. The invite response message 134 can be expressed using 2000K defined by the SIP. The 2000K represents an acceptance of the request. The 2000K includes SDP that is information on a session based application service intended for provision.

In response to the received invite response message 134, the sender terminal 100 sends data by a wireless LAN communication, using information on the wireless LAN AP 108 connecting with the receiver terminal 112, in data sending step 136. The information is included in the invite response message 134. In the data sending step 136, data sending between the wireless LAN AP 104 and the wireless LAN AP 108 is implemented over the Internet, using a Real-time Transport Protocol (RTP) defined for real-time data transport such as streaming, or using a Message Session Relay Protocol (MSRP) defined for session based message forward. The RTP and the MSRP each are based on two standards: “IETF RFC 3550” and “IETF Internet Draft Draft-IETF-Simple-MSRP-Relays”.

After that, upon termination of the IMS service, a wireless LAN disconnecting procedure 138 is implemented, and power to the wireless LAN communication unit of each of the sender terminal 100 and the receiver terminal 112 is cut off, thereby reducing power consumption.

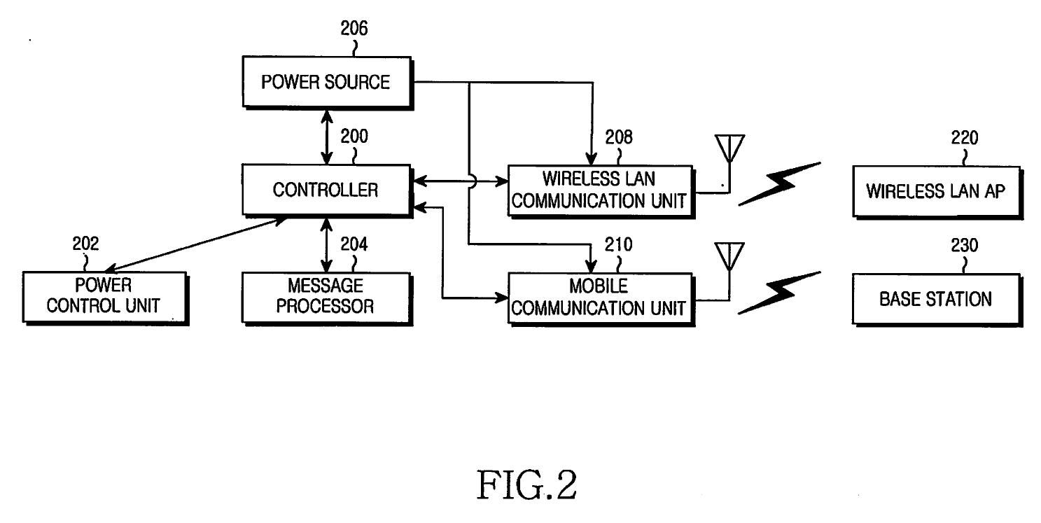

FIG. 2 illustrates an IMS service apparatus having a power saving function in a mobile terminal accessible to a wireless LAN and a mobile 10 communication system according to the present invention. Referring to FIG. 2, the mobile terminal includes a controller 200, a power control unit 202, a message processor 204, a power source 206, a wireless LAN communication unit 208 and a mobile communication unit 210.

The power control unit 202 controls the power source 206 to supply power to the wireless LAN communication unit 208 when the message processor 204 receives an invite response message for requesting the use of the wireless LAN or senses an event for initiating an IMS service using the wireless LAN. The power control unit 202 controls the power source 206 to cut off power to the wireless LAN communication unit 208 when a wireless LAN communication fails or ends.

The message processor 204 generates a message for providing the IMS service, and judges and processes a received message. The message processor 204 generates a register request message for registering the mobile terminal to the IMS server 106 via the mobile communication unit 210, and, upon receipt of a register response message from the IMS server 106, checks the received register response message as to whether the mobile terminal is registered to the IMS server 106. The message processor 204 generates an invite request message for providing the IMS service using the wireless LAN via the wireless LAN communication unit 208, and, upon receipt of the invite response message, checks the received invite response message for information on a wireless LAN AP connecting with a receiver terminal. If receiving an invite request message, the message processor 204 checks the received invite request message as to whether an IMS service requires a wireless LAN communication. If the check result is that the IMS service requires the wireless LAN communication, the message processor 204 checks information on a wireless LAN AP 220 with which it connects via the wireless LAN communication unit 208, generates an invite response message including the information on the wireless LAN AP 220, and sends the generated invite response message to a terminal, which has sent the invite request message, via the wireless LAN communication unit 208.

The controller 200 controls and performs functions of the power control unit 202 and the message processor 204. In the present invention, they are separately constructed and illustrated so as to distinguish and describe the respective functions. Accordingly, when a product is actually realized, it can be constructed to process all of the functions by the controller 200. Alternately, it can be constructed to process only part of the functions by the controller 200.

The power source 206 is for supplying power for the mobile terminal. The power source 206 supplies power to the wireless LAN communication unit 208 under the control of the power control unit 202.

If supplied with power by the power source 206, the wireless LAN communication unit 208 searches the accessible wireless LAN AP 220. The wireless LAN communication unit 208 exchanges data, connecting with the searched wireless LAN AP 220 in compliance with IEEE 802.11 standard.

The mobile communication unit 210 communicates with a base station 230, and accesses the mobile communication network, thereby exchanging data. According to the present invention, the mobile communication unit 210 sends the register request message to the IMS server 106 and receives the register response message from the IMS server 106 over the mobile communication network, thereby registering the mobile terminal to the IMS server 106, and receives the invite request message.

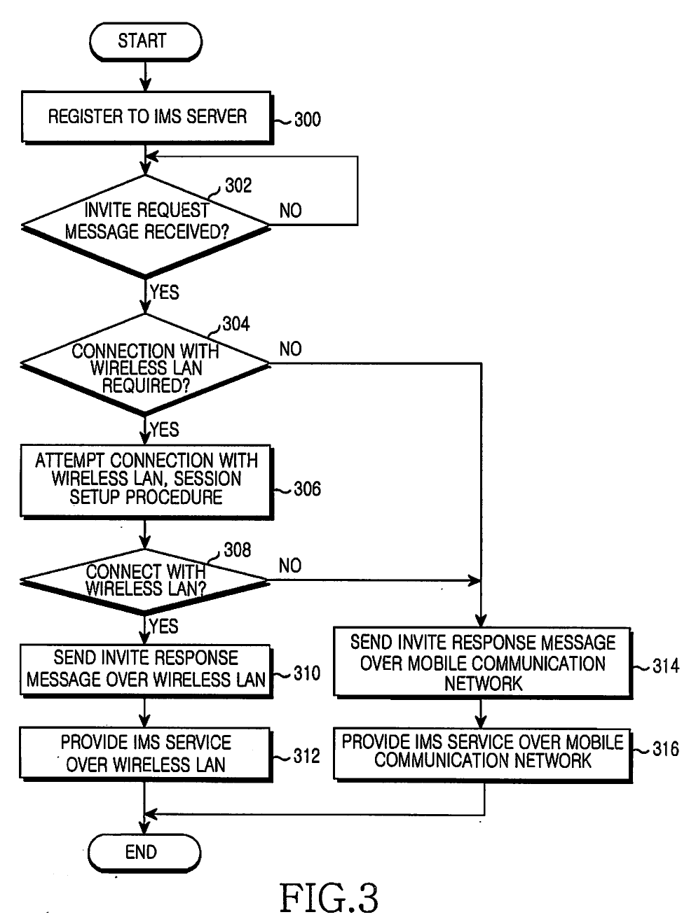

FIG. 3 illustrates a procedure of receiving the invite request message and providing the IMS service in the mobile terminal accessible to the wireless LAN and the mobile communication system according to the present invention.

Referring to FIG. 3, the mobile terminal registers to the IMS server in Step 300. The mobile terminal checks whether it receives an invite request message in Step 302. If not, the Step 302 is repeatedly performed until the mobile terminal receives the invite request message. If the check result is that the mobile terminal receives the invite request message, the mobile terminal checks whether the IMS service requested by the invite request message is of a type requiring a connection with the wireless LAN in Step 304. If the check result is that the IMS service does not require the connection with the wireless LAN, the mobile terminal generates an invite response message using the mobile communication network, and sends the invite response message over the mobile communication network in Step 314. The mobile terminal provides the IMS service over the mobile communication network in Step 316.

However, if the check result is that the IMS service requires the connection with the wireless LAN in the Step 304, the mobile terminal supplies power to the wireless LAN communication unit 208, and attempts the connection with the wireless LAN and concurrently performs a session setup procedure in Step 306. The mobile terminal checks whether it connects with the wireless LAN in Step 308. If the check result is that the mobile terminal does not connect with the wireless LAN because of absence of a neighbor wireless LAN AP, the mobile terminal cuts off power to the wireless LAN communication unit 208, and proceeds to the Step 314.

However, if the check result is that the mobile terminal connects with the wireless LAN in the Step 308, the mobile terminal generates an invite response message using the wireless LAN, and sends the invite response message over the wireless LAN in Step 310. The mobile terminal then provides the IMS service over the wireless LAN in Step 312, and if the IMS service terminates, the mobile terminal cuts off power to the wireless LAN communication unit 208.

As described above, the present invention provides the IMS service apparatus and method in the mobile terminal accessible to the wireless LAN and the mobile communication system, for checking the use or nonuse of the wireless LAN communication unit by the invite request message received from the mobile communication network, and supplying power to the wireless LAN communication unit only when communicating over the wireless LAN, thereby reducing power consumption. Accordingly, the present invention only supplies power to the wireless LAN communication unit when it uses the wireless LAN, thereby saving power.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An Internet Protocol (IP) Multimedia Subsystem (IMS) service apparatus having a power saving function in a mobile terminal, the apparatus comprising:
a mobile communication unit for connecting with a mobile communication network, communicating with an IMS server, registering the mobile terminal to the IMS server and receiving an invite request message;
a wireless Local Area Network (LAN) communication unit for searching an accessible wireless LAN Access Point (AP), and sending an invite response message upon connection with the wireless LAN AP; and
a message processor for, upon receipt of the invite request message, checking whether the received invite request message is for requesting an IMS service requiring a connection with a wireless LAN, and, upon checking that the IMS service requires the connection with the wireless LAN, attempting a connection with the wireless LAN AP via the wireless LAN communication unit, and, upon connection with the wireless LAN AP, generating an invite response message including information on the wireless LAN AP, and sending the generated invite response message to a terminal which has sent the invite request message, via the wireless LAN communication unit.

2. The apparatus of claim 1, further comprising a power source for supplying power to the wireless LAN communication unit; and
a power control unit for controlling the power source to supply power to the wireless LAN communication unit when the invite request message received from the message processor requires the connection with the wireless LAN.

3. The apparatus of claim 2, wherein the message processor sends a register request message to the IMS server via the mobile communication unit, receives a register response message from the IMS server, and registers the mobile terminal to the IMS server.

4. The apparatus of claim 2, wherein the power control unit cuts off power to the wireless LAN communication unit upon failure of the connection with the wireless LAN or termination of the IMS service.

5. The apparatus of claim 2, wherein the message processor provides the IMS service over the mobile communication network upon checking that the invite request message is for requesting the IMS service that does not require the connection with the wireless LAN.

6. The apparatus of claim 2, wherein the message processor performs a session setup procedure until the connection with the wireless LAN AP, upon attempting the connection with the wireless LAN AP via the wireless LAN communication unit.

7. The apparatus of claim 2, wherein the message processor provides the IMS service over the mobile communication network upon failure of the connection with the wireless LAN AP as a result of attempting the connection with the wireless LAN AP via the wireless LAN communication unit.

8. An Internet Protocol (IP) Multimedia Subsystem (IMS) service method having a power saving function in a mobile terminal, the method comprising:
registering the mobile terminal to an EMS server over a mobile communication network;
checking, upon receipt of an invite request message over the mobile communication network, whether the invite request message is for requesting an IMS service requiring a connection with a wireless Local Area Network (LAN);
supplying power to a wireless LAN communication unit, upon checking that the IMS service requires the connection with the wireless LAN;
attempting a connection with a wireless LAN Access Point (AP) via the wireless LAN communication unit supplied with power;
generating, upon the connection with the wireless LAN AP, an invite response message including information on the wireless LAN AP; and
sending over the wireless LAN the invite response message to a terminal which has sent the invite request message.

9. The method of claim 8, wherein the registering of the mobile terminal to the IMS server further comprises:
sending a register request message to the IMS server over the mobile communication network;
receiving a register response message from the IMS server; and
registering the mobile terminal to the IMS server.

10. The method of claim 8, further comprising cutting off power to the wireless LAN communication unit upon failure of the connection with the wireless LAN in the attempting of the connection with the wireless LAN AP or upon termination of the IMS service.

11. The method of claim 8, further comprising providing the IMS service over the mobile communication network upon checking that the invite request message is for requesting the IMS service that does not require the connection with the wireless LAN.

12. The method of claim 8, further comprising performing a session setup procedure until the connection with the wireless LAN AP after the attempting of the connection with the wireless LAN AP.

13. The method of claim 8, further comprising providing the IMS service over the mobile communication network, upon failure of the connection with the wireless LAN AP, after the attempting of the connection with the wireless LAN AP via the wireless LAN communication unit supplied with power.

14. An Internet Protocol (IP) Multimedia Subsystem (IMS) service apparatus having a power saving function in a mobile terminal, the apparatus comprising:
a mobile communication unit for connecting with a mobile communication network, communicating with an IMS server, registering the mobile terminal to the IMS server and receiving an invite request message;
a wireless Local Area Network (LAN) communication unit for searching an accessible wireless LAN Access Point (AP), and sending an invite response message upon connection with the wireless LAN AP; and
a message processor for, upon receipt of the invite request message, checking whether a IMS service requires the connection with the wireless LAN, generating an invite response message including information on the wireless LAN AP, and sending the generated invite response message to a terminal which has sent the invite request message.

15. An Internet Protocol (IP) Multimedia Subsystem (IMS) service method in a mobile terminal, the method comprising:
checking, upon receipt of an invite request message over the mobile communication network, whether the invite request message is for requesting an IMS service requiring a connection with a wireless Local Area Network (LAN);
supplying power to a wireless LAN communication unit;
attempting a connection with a wireless LAN Access Point (AP) via the wireless LAN communication unit supplied with power;
generating an invite response message including information on the wireless LAN AP; and
sending over the wireless LAN the invite response message to a terminal which has sent the invite request message.
